(19) United States
(12) Patent Application Publication
(10) Pub. No.: US 2009/0103999 A1
(43) Pub. Date: Apr. 23, 2009

(54) Toggle bolt assembly

(76) Inventor: Dominick Joseph Fucito, Sagamore Beach, MA (US)

Correspondence Address: Dominick J. Fucito, 8 Jones Lane, Sagamore Beach, MA, 02562, US

(21) Appl. No.: 11/975,957

(22) Filed: Oct. 23, 2007

(51) Int. Cl. F16B 21/07

(52) U.S. Cl. 411/342

(57) ABSTRACT

An improved toggle bolt assembly consisting of a toggle nut 100, collar 200, and screw 300, wherein the toggle nut 100 consists of an internally threaded cylindrical sleeve 110, a first winged member 120, and a second winged member 130. The cylindrical sleeve 110 of the toggle nut 100 engages with a collar 200, acting to center the assembly, hold the toggle nut 100 and collar 200 in place without engagement of the screw 300, and eliminate the need to apply tension to the screw 300 during installation.

### CROSS-REFERENCE TO RELATED APPLICATIONS

Not Applicable

### STATEMENT REGARDING FEDERALLY SPONSORED RESEARCH OR DEVELOPMENT

Not Applicable

REFERENCE TO SEQUENCE LISTING, A TABLE, OR A COMPUTER PROGRAM LISTING COMPACT DISC APPENDIX

Not Applicable

### BACKGROUND OF THE INVENTION

1. Field of Invention

This invention generally relates to an improved anchor, specifically the type of anchor commonly referred to as a toggle bolt.

2. Prior Art

Toggle bolts are used to secure objects to supportive structures such as walls. An example of a prior art toggle bolt design is disclosed in U.S. Pat. No. 7,226,261. It consists of a machine screw and a mating nut with two diametrically opposed pins which engage two wing members. These wing members rotate into a compressed orientation to allow insertion of the assembly into a hole in the supportive structure. Once positioned in the hole, the wings spring open and are brought into bearing against the surface of the supportive structure by pulling and tightening the mating screw.

Of the many types of wall anchors available, toggle bolts are generally considered to possess the highest strength. Despite its superior strength however, there are a number of weaknesses in the design of prior art toggle bolts. One significant drawback is the requirement that the machine screw and mating nut be pre-assembled to the object to be secured. This is required because the prior art design relies on the screw to hold the nut in place behind the wall. As a result, the typical installation sequence is to pre-attach the screw and nut to the object to be secured, compress the attached wings, push them through a pre-drilled hole in the wall, then pull back and tighten the screw to secure the object. This sequence becomes difficult when multiple toggle bolts are required to secure a large object. For example, to mount a large cabinet with four toggle bolts would require that the cabinet be held in place while simultaneously reaching around the back of the cabinet to align, compress, and insert each toggle nut into its mating hole. A possible solution is to drill oversized holes in the cabinet and install each toggle assembly in sequence through the front. However, this requires drilling oversized holes in the cabinet which could be detrimental to its structure. It would also require the use of additional washers, and would result in a sloppy installation.

A second weakness in the design of prior art toggle bolts is the requirement that tension be applied to the screw when it is being tightened. This tension is required to bring the wings nut into bearing against the inside surface of the wall to prevent the nut from rotating as the screw is tightened. This becomes a problem as the head of the screw is drawn close to the object to be secured since it becomes difficult to grasp the screw to apply the necessary tension.

A third weakness in the design of prior art toggle bolts is the size of the hole which must be created in the wall relative to the size of the screw. The hole diameter must be significantly larger than the screw diameter to allow insertion of the compressed wings. As a result, the secured object can, over time, slip downward due to gravity until the screw contacts the bottom of the hole.

A number of prior art toggle bolt designs have sought to alleviate the weaknesses identified above, with limited success. For example, the designs disclosed in U.S. Pat. Nos. 6,203,260, RE 35,358, and 5,209,621 provide centering devices which prevent the secured objects from slipping downward over time, but do not include means to hold the nut in place without the screw, and do not provide means to prevent rotation of the nut without applying tension to the screw.

The design disclosed in U.S. Pat. No. 6,161,999 has the following weaknesses:

a) The toggle bolt assembly is rendered useless if the locking collar is accidentally engaged prior to installation in the wall;
b) installation involves the additional step of cutting off the excess plastic legs with wire cutter or other suitable tool;
c) once installed in the wall, the device is difficult to remove;
d) once installed, further tightening of the assembly is difficult, since this would require that both leg stubs which have been cut substantially flush with the locking collar be grasped and pulled outward while simultaneously pushing in the locking collar;
e) the device is relatively expensive to manufacture, retailing for approximately four times the cost of a conventional toggle bolt of the same size.

The designs disclosed in U.S. Pat. Nos. 4,668,144, 4,997,327, and 2,024,871 do not include means to hold the nut in place behind the wall. Similarly, the design disclosed in U.S. Pat. No. 4,822,226 does not provide an effective means to hold the nut in place behind the wall. Although the nut would be retained by the assembly if the screw were to be removed, re-engagement of the screw with the nut would be difficult since the nut would not be visible to allow proper alignment with the screw, and the screw would have a tendency to push the nut along the retainer until it contacts the tipping finger, causing the toggle nut to tip and thereby further hindering the effort to properly align and engage the nut and screw.

The design disclosed in U.S. Pat. No. 3,389,631 will not effectively hold the toggle nut in place behind the wall. Barbs pushed into a centering plug composed of cork, rubber, Styrofoam and other similar materials do not provide a dependable means to secure the nut. In addition, dimensional constraints require that the barbs be adjacent to the inner bore of the plug and this proximity reduces the holding capability of the plug.

### OBJECTS AND ADVANTAGES

The object of the present invention is to provide an improved toggle bolt design, with the following advantages over the prior art:

a) the nut is effectively held in place without engagement of the screw,
b) the screw does not require the application of tensile force during installation,
c) the assembly cannot slip downward over time,
d) the assembly is easy to install, and can be easily removed if no longer required, and
e) the assembly is relatively inexpensive to manufacture.

### BRIEF SUMMARY OF THE INVENTION

The present invention incorporates an internally threaded sleeve in lieu of the prior art nut, and also incorporates a centering collar. When installed, the internally threaded sleeve, which is positioned on the inside surface of the wall skin, is engaged with a hole in the centering collar, which is positioned on the outside of the wall. These components are sized to provide a tight fit to the wall and to each other, such that they will remain in a fixed position on the wall without engagement of the screw.

### BRIEF DESCRIPTION OF THE SEVERAL VIEWS OF THE DRAWING

FIG. 1 is a side view of the preferred embodiment consisting of a toggle nut, collar, and screw, securing an object (shown in phantom) to a supportive structure (also shown in phantom).

FIG. 2 is a side view of the toggle nut component of the preferred embodiment, shown in an expanded position.

FIG. 3 is a side view of the toggle nut component of the preferred embodiment, shown in a compressed position.

FIG. 4 is a sectional view of the toggle nut component of the preferred embodiment in its compressed position, taken along line 4-4 in FIG. 3.

FIG. 5 is a side view of the collar component of the preferred embodiment.

FIG. 6 is a front view of the collar component of the preferred embodiment.

FIG. 7 is a sectional view of the collar component of the preferred embodiment, taken along line 7-7 in FIG. 5.

FIG. 8 is a sectional view of the collar component of the preferred embodiment, taken along line 8-8 in FIG. 5.

FIG. 9 is a side view of the screw component of the preferred embodiment.

FIG. 10A is a side view illustrating the first step of the toggle bolt installation of the preferred embodiment of the invention.

FIG. 10B is a side view illustrating the second step of the installation of the preferred embodiment of the invention.

FIG. 10C is a side view illustrating the third step of the installation of the preferred embodiment of the present invention.

FIG. 10D is a side view illustrating the fourth step of the installation of the preferred embodiment of the present invention.

FIG. 11 is a side view of an alternate embodiment of the collar.

FIG. 12 is a side view of a second alternate embodiment of the collar.

FIG. 13 is a side view of an alternate embodiment of the toggle nut.

FIG. 14 is a front view of the second alternate embodiment of the collar.

FIG. 15A is a side view illustrating the initial step in the abandonment of an alternate embodiment of the invention.

FIG. 15B is a side view illustrating the final step in the abandonment of an alternate embodiment of the invention.

FIG. 16A is a side view illustrating a second alternate embodiment of the toggle nut.

FIG. 16B is a side view illustrating a third alternate embodiment of the collar.

FIG. 17 is a side view illustrating a third alternate embodiment of the toggle nut.

FIG. 18 is an end view illustrating a fourth alternate embodiment of the toggle nut in a compressed orientation.

### DETAILED DESCRIPTION OF THE INVENTION

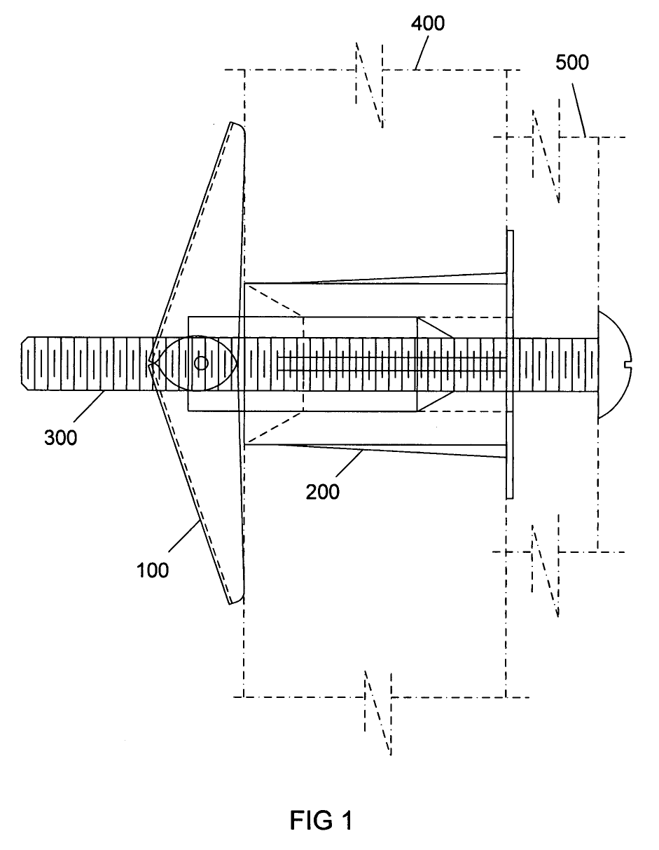

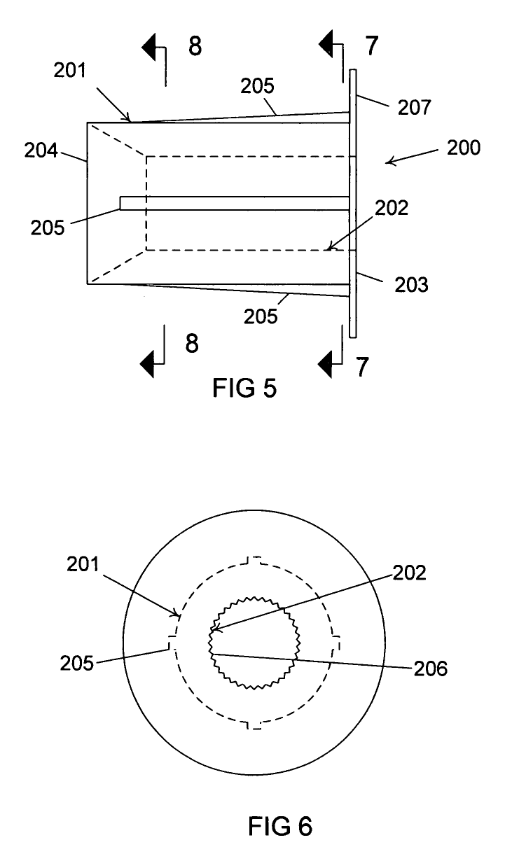

### FIGS. 1 Through 9

### Preferred Embodiment

The preferred embodiment of the present invention is illustrated in FIGS. 1 through 9. As illustrated in FIG. 1, the present invention is composed of three separate elements: a toggle nut 100, a collar 200, and a screw 300.

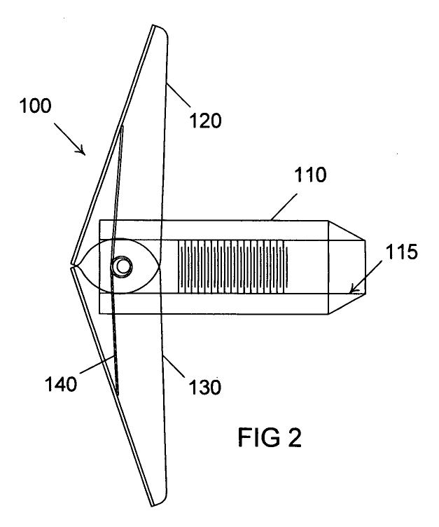

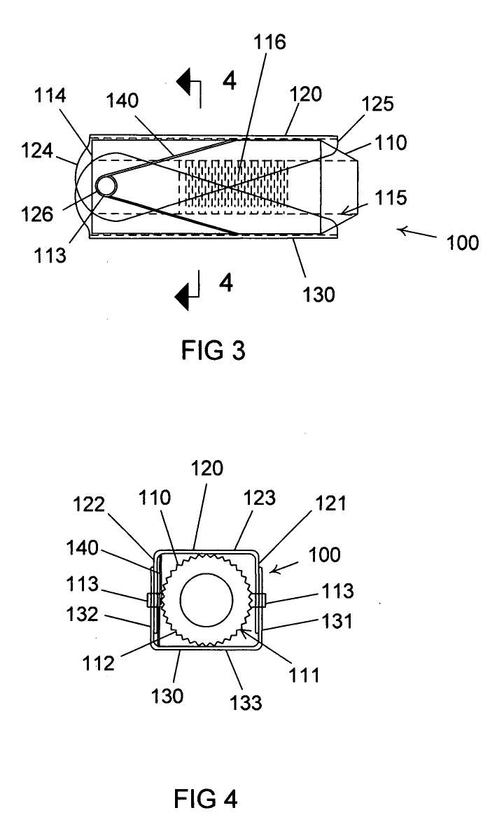

The toggle nut 100 is illustrated in FIGS. 2, 3 and 4. It is composed of a cylindrical sleeve 110, a first wing member 120, a second wing member 130, and a spring 140. As illustrated in FIG. 4, the cylindrical sleeve 110 has a substantially round outer surface 111 with a plurality of regularly spaced saw tooth shaped grooves 112. As illustrated in FIGS. 3 and 4, the outer surface 111 also includes two pins 113 diametrically opposed to each other and located near an end 114 of the sleeve 110. An inner surface 115 of the sleeve 110 has internal threads 116.

As illustrated in FIGS. 3 and 4, the first wing member 120 is of a substantially tapered channel cross section, with a first flange 121, a second flange 122, a web 123, a first end 124, and a second end 125. The first flange 121 and second flange 122 are outfitted with holes 126 near the first end 124. The first wing member 120 is attached to the cylindrical sleeve 110 by engaging the diametrically opposed pins 113 with the holes 126. The web 123 is of sufficient width to allow the sleeve 110 to nest inside the wing 120 when said wing is rotated about the sleeve pin 113 into a substantially parallel orientation with said sleeve.

The second wing member 130 is composed of a first flange 131, a second flange 132, and a web 133. It is of substantially the same geometry as the first wing member 120, except that the web 133 is slightly wider than web 123, such that the first wing member 120 may nest inside the second wing member 130, as illustrated in FIG. 4. Similar to the first wing member 120, the second wing member 130 is also attached to sleeve 110 by engaging the diametrically opposed pins 113 with the holes in the flanges.

The first wing member 120 and second wing member 130 are held in a substantially perpendicular orientation relative to the sleeve 110 by a wire spring 140. The spring 140 is of a design similar to those used in the prior art and does not warrant the inclusion of a detailed description herein.

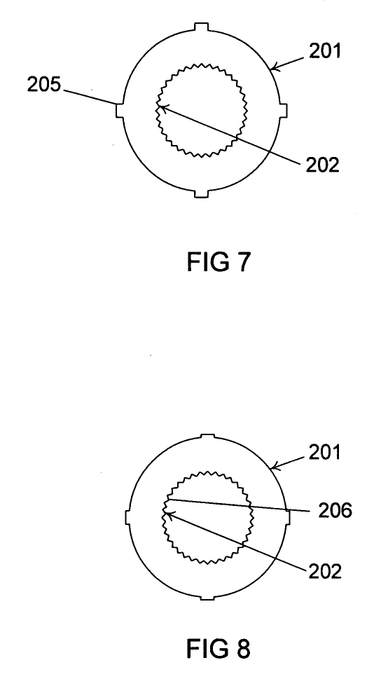

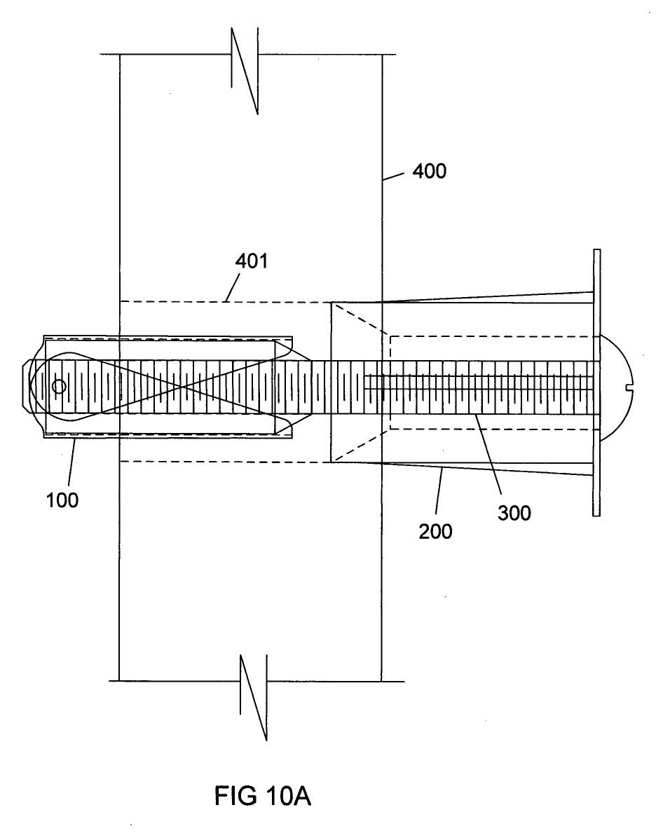

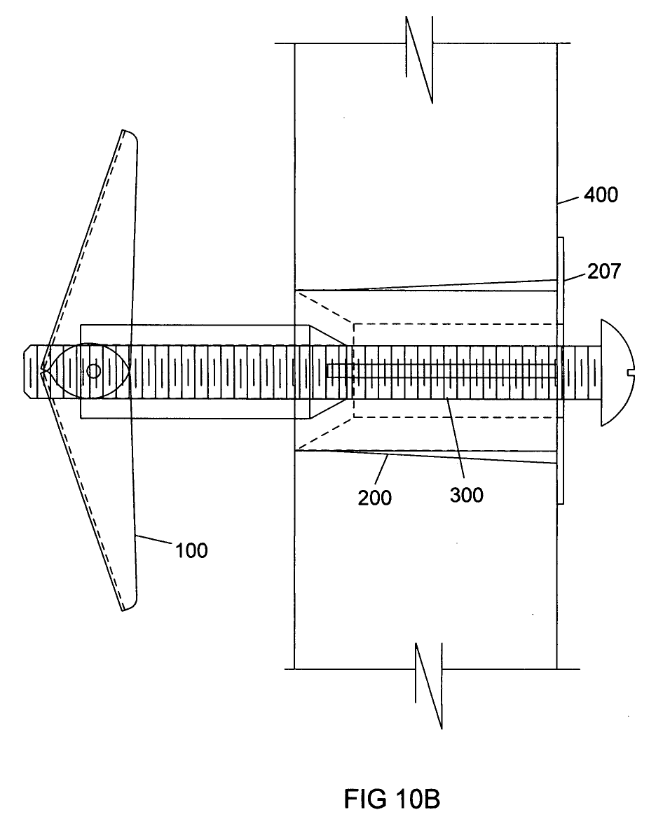

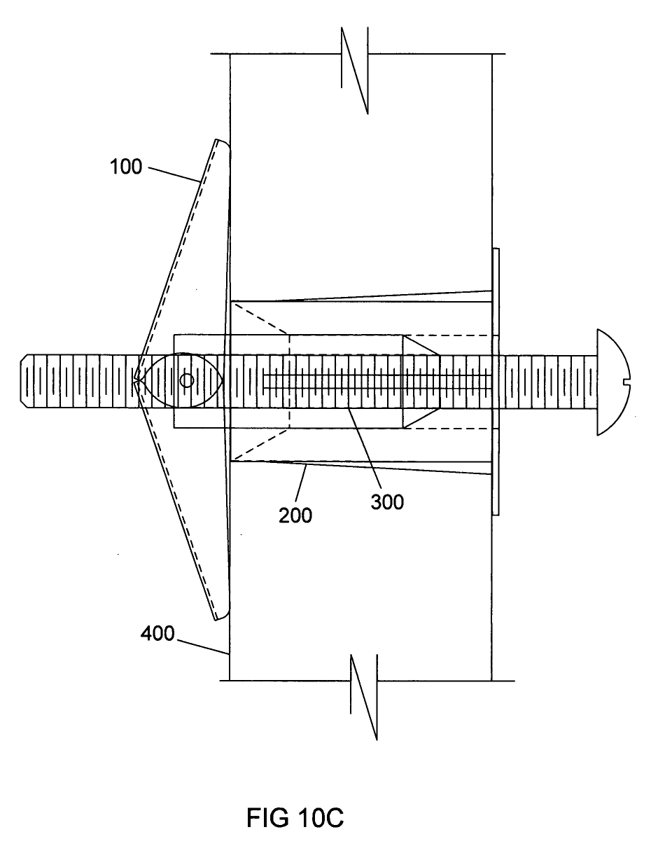

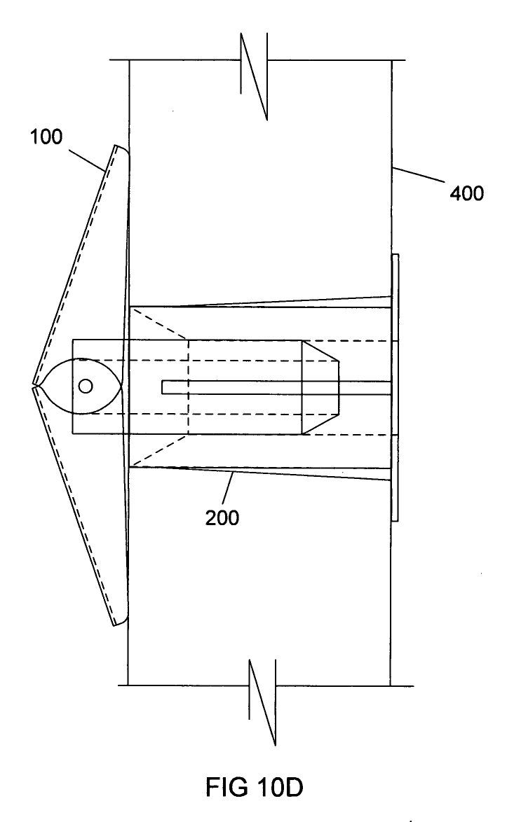

The preferred embodiment of the collar 200 is illustrated in FIGS. 5, 6, 7, and 8. It is made of plastic and is substantially cylindrical in shape with a hollow center. It has an outer surface 201, an inner surface 202, a first end 203, and a second end 204. The outer surface 201 is substantially round, with a plurality of equally spaced keys 205. The inner surface 202 is substantially round, with a plurality of regularly spaced saw tooth shaped ridges 206, sized to engage with the grooves 112 on the sleeve 110. The first end 203 has a flange 207 of circular shape. As illustrated in FIG. 10A, the outside diameter of the collar 200 is sized to provide an interference fit with the mounting hole 401 in the supportive structure 400. Cross sections of the collar taken along lines 7-7 and 8-8 are illustrated in FIGS. 7 and 8 respectively.

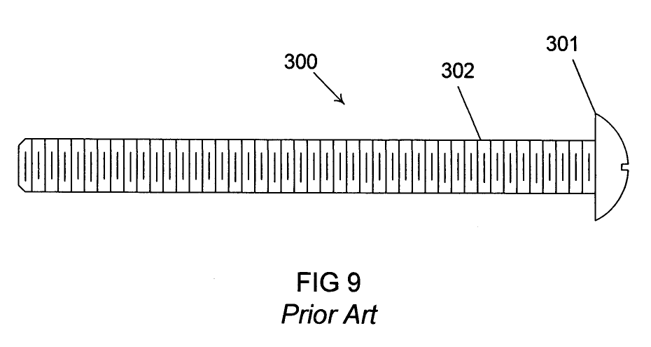

As illustrated in FIG. 9, the screw 300 is comprised of a head 301 and a threaded shank 302. It is of a design similar to those used in the prior art and does not warrant the inclusion of a detailed description herein.

### Operation of Preferred Embodiment

Operation of the preferred embodiment of the present invention is illustrated in FIGS. 10A through 10D. As illustrated in FIG. 10A, a hole 401 is first drilled in the supportive structure 400 of sufficient dimension to allow passage of the compressed toggle nut 100. Next, the toggle nut 100, sleeve 200 and screw 300 are assembled and inserted into the hole. As illustrated in FIG. 10B, the collar is then pushed into the hole until the flange 207 contacts the supportive structure 400. As illustrated in FIG. 1C, tension is then applied to the screw 300 to draw the sleeve 110 of the toggle nut 100 into the collar 200. As illustrated in FIG. 10D, the screw 300 is then removed, leaving the toggle nut 100 and collar 200 in place on the supportive structure 400. This geometry is particularly advantageous when a plurality of toggle bolts are used to secure a large object such as a cabinet to a wall, since it eliminates the need to pre-attach the toggle bolts to the object, then simultaneously align and compress each toggle assembly during installation.

To remove the preferred embodiment of the present invention, the screw 300 is removed, then used to push the toggle nut 100 out of the collar 200, after which the collar 200 can be withdrawn from the hole 401. This complete removal of the assembly is desirable in drywall and other applications where the toggle bolt is no longer required and the hole 401 is to be repaired for aesthetic purposes.

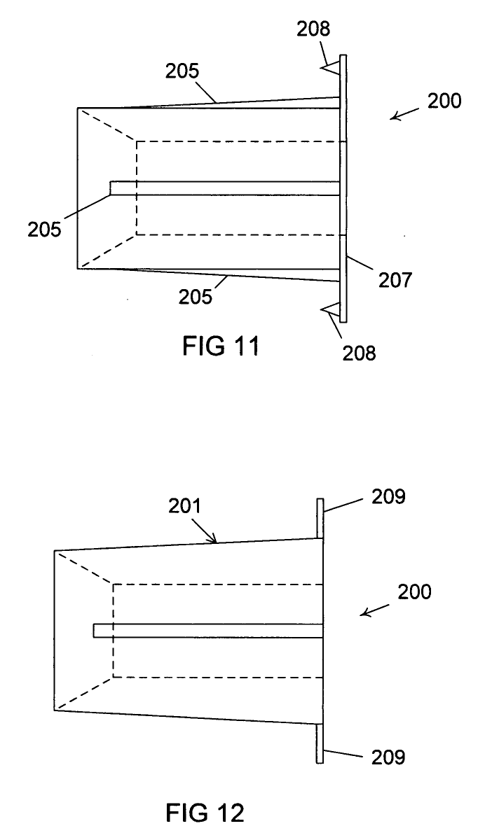

### FIGS. 11 Through 18

### Alternate Embodiments

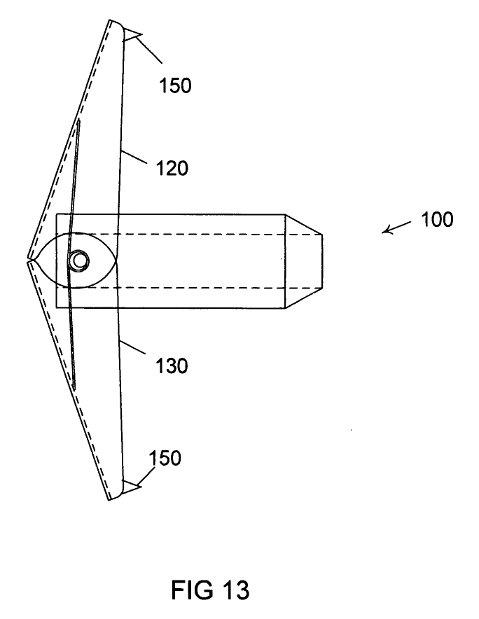

A number of alternate embodiments of the present invention are possible. For example, the collar flange 207 may be outfitted with one or more teeth 208 as illustrated in FIG. 11 to prevent unwanted rotation of the collar during engagement of the screw. The teeth 208 may be used in lieu of or in addition to the keys 205. Alternatively, the outside surface 201 may be tapered as illustrated in FIG. 12 to create a tighter fit intended to prevent this unwanted rotation. Likewise, the first wing 120 and the second wing 130 may be outfitted with one or more teeth 150 to prevent rotation of the toggle nut during engagement of the screw, as illustrated in FIG. 13.

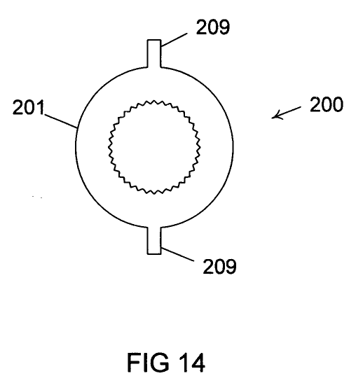

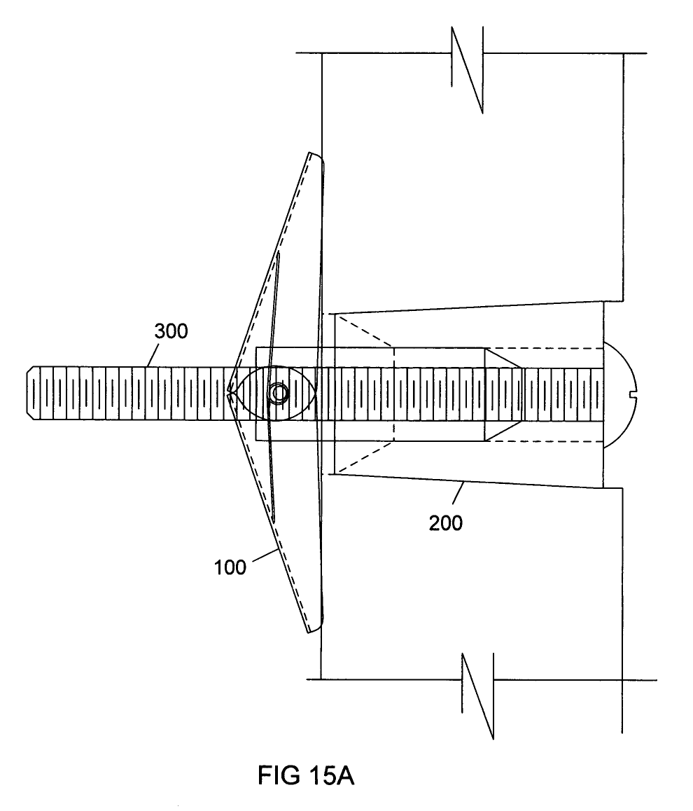

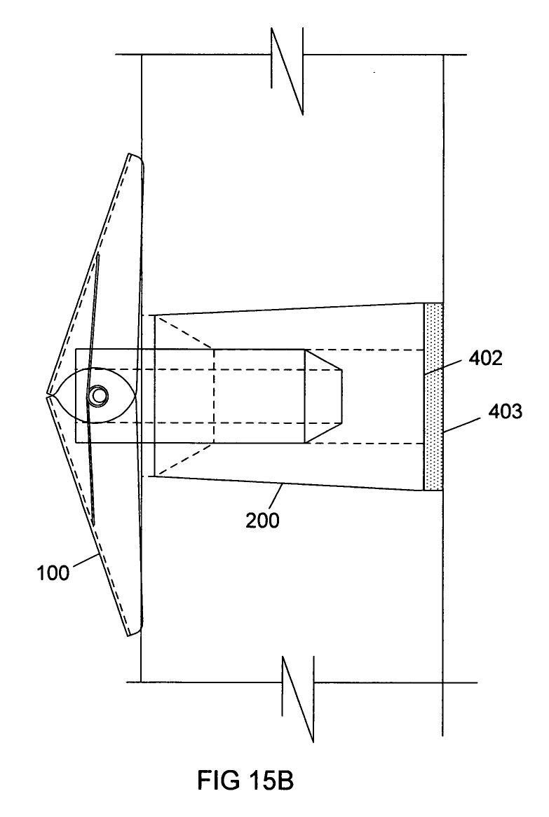

The collar flange 207 could be replaced by two tabs 209, as illustrated in FIGS. 12 and 14. In drywall applications, the tabs 209 could be made removable. This would be of benefit if the toggle bolt is temporary and will eventually be removed. As shown in FIG. 15A, after removal of the tabs 209, the screw 300 could be tightened to draw the collar 200 into the wall. As illustrated in FIG. 15B, the screw is then withdrawing and the resulting depression 402 is filled with a suitable patching material 403. The presence of the recessed collar provides a backing, thereby facilitating repair of the hole 401.

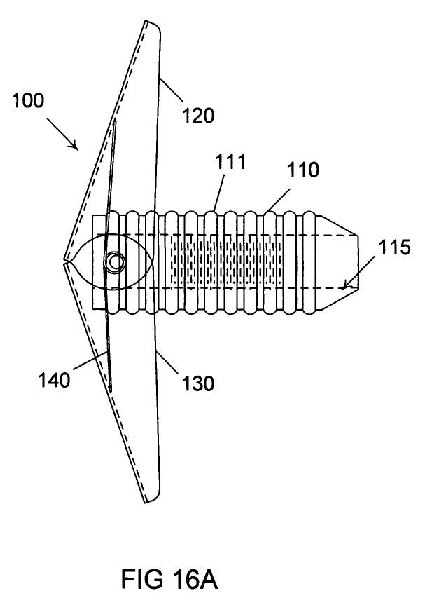

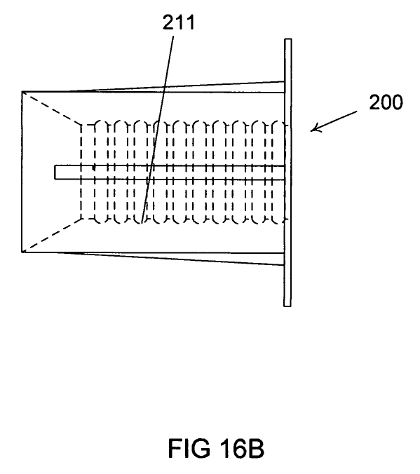

The interfacing surfaces of the toggle nut sleeve 110 and collar 200 may also be altered. For example, these surfaces could be circular in shape and of such a diameter as to create an interference fit. Alternatively, the toggle nut sleeve 110 could be made with circular ridges 111 as illustrated in FIG. 16A, and the collar 200 could be made with complimentary grooves 211 as illustrated in FIG. 16B.

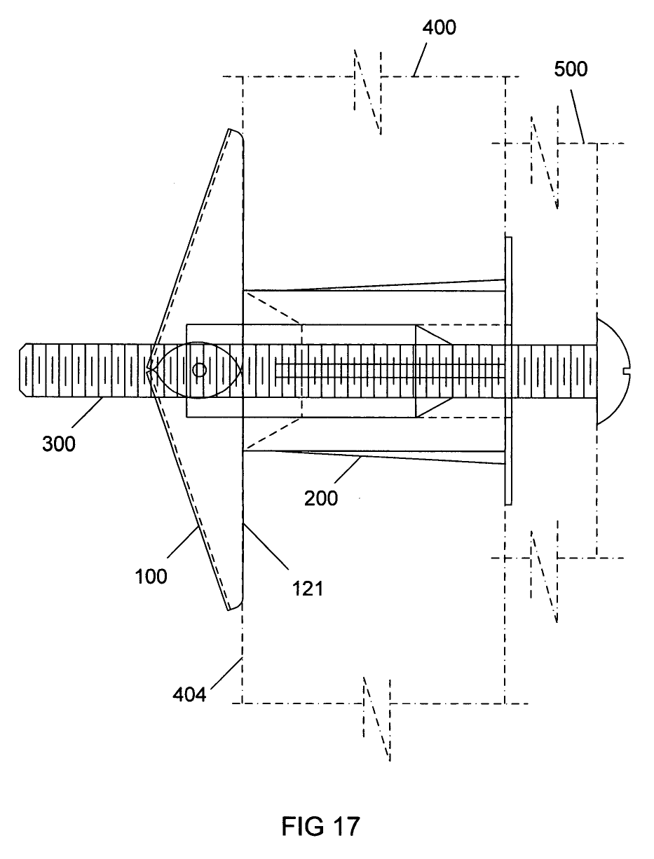

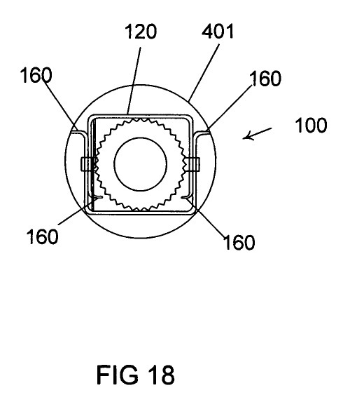

The precise shape of the wings may also be altered. For example, the shape could be adjusted such that an inner surface 121 is fully bearing on the inside surface 404 of the supportive structure 400 when the wing is in the open position, as illustrated in FIG. 17. Alternatively or in addition, the wings could be outfitted with additional bearing surfaces in the form of flange extensions 160 which project perpendicularly from the wing flanges and are sized so as to not hinder compression of the toggle nut assembly or prevent insertion into the hole 401, as illustrated in FIG. 18.

### Operation of Alternate Embodiments

One alternate embodiment illustrated in FIGS. 15A and 15B is intended for drywall applications and is designed to allow the collar 200 and toggle nut to be abandoned in the wall if no longer required. As described previously, the projecting tabs 209 would be removed, and the screw would be used to draw the collar 200 into a recessed position, relative to the outer wall surface. The recess may then be filled with suitable patching material. Other than this added feature associated with this alternate embodiment, the operation of the alternate embodiments is substantially the same as the operation of the preferred embodiment.

The alternate embodiments described above may be implemented singly or in any combination to suit the specific needs of the end user, and although the descriptions above contain many specifics, these should not be construed as limiting the scope of the invention, but merely providing illustrations of some of the presently preferred embodiments. Thus, the scope of the invention should be determined by the appended claims and their legal equivalents, rather than by the examples given.

What is claimed is:

1. An improved toggle bolt assembly wherein the improvement comprises:
(a) a toggle nut which includes:
(1) a sleeve with diametrically opposed pins, said sleeve being internally threaded to engage a screw,
(2) a first wing element with means to connect to and rotate about pins of said sleeve,
(3) a second wing element with means to connect to and rotate about pins of said sleeve,
(4) a spring element which holds first and second wing elements in a position substantially perpendicular to the sleeve, which can be compressed to allow rotation of the first wing element and second wing element to positions substantially parallel to the sleeve
(b) a collar which includes:
(1) an outer surface of dimension to engage in a hole in a supportive structure, said outer surface having means to substantially prevent movement of collar with respect to supportive structure
(2) a flange with dimension sufficient to substantially prevent passage of collar through hole in supportive structure
(3) an inner surface of dimension to engage the toggle nut sleeve with means to substantially limit rotation of said sleeve with respect to the collar
whereby the engagement of said toggle nut and collar centers the assembly, fixes the assembly to the supportive structure, and substantially prevents rotation of the assembly or portions thereof during engagement of a threaded screw.

2. The toggle bolt assembly of claim 1 wherein the toggle nut sleeve outer surface is substantially round with a plurality of saw-toothed ridges, and the collar inside surface is substantially round with a plurality of saw-toothed grooves sized to engage with ridges of said sleeve.

3. The toggle bolt assembly of claim 1 wherein the toggle nut sleeve outer surface is substantially round with a plurality of circular ridges, and the collar inside surface is substantially round with a plurality of circular grooves sized to engage with ridges of said sleeve.

4. The toggle bolt assembly of claim 1 wherein the toggle nut sleeve outer surface is substantially round, and the collar inside surface is substantially round and of dimension to provide an interference fit when said sleeve is engaged with said collar.
